(19) United States
(12) Patent Application Publication
(10) Pub. No.: US 2010/0048376 A1
(43) Pub. Date: Feb. 25, 2010

(54) GRANULES OF METALS AND METAL OXIDES

(75) Inventors: Monika Oswald, Hanau (DE); Klaus Deller, Hainburg (DE); Tassilo Moritz, Freiberg (DE); Manfred Nebelung, Dresden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignees: EVONIK DEGUSSA GmbH, Essen (DE); FRAUNHOFER-GESELL. ZUR FOERD. DER ANG. FORS. E.V., Muenchen (DE)

(21) Appl. No.: 12/515,751

(22) PCT Filed: Nov. 8, 2007
(86) PCT No.: PCT/EP07/62069

§ 371 Date: May 21, 2009

(30) Foreign Application Priority Data
Nov. 24, 2006 (DE) 102006055975.4

(51) Int. Cl. C04B 35/482; C04B 35/10; C04B 35/04; C04B 35/14

(52) U.S. Cl. 501/104; 501/103; 501/127; 501/108; 501/133

(57) ABSTRACT

Process for preparing granules of oxidic or nonoxidic metal compounds, characterized in that a dispersion which comprises water, oxidic or nonoxidic metal compounds and at least one dispersant is spray-dried,—where the proportion of oxidic or nonoxidic metal compounds is 40 to 70% by weight and the sum of the proportions of water and the particles is at least 70% by weight and—the particles have a BET surface area of 20 to 150 m²/g and a median of the particle size of less than 100 nm,—where the dispersant is present in the dispersion with a proportion of 0.25 to 10% by weight based on the oxidic or nonoxidic metal compounds and—where the spray-drying is performed by atomization with air in the cocurrent principle or fountain principle, and an air inlet temperature of 170 to 300° C. and an air outlet temperature of 90 to 130° C. are selected.

The invention is related to a process for preparing granules of oxidic and nonoxidic metal compounds and to the granules themselves.

In the field of industrial ceramics, many expectations are linked to the use of nanoscale powders with regard to an improvement in the mechanical, tribological, optical, surface-chemical and structural properties.

In order to bring to bear the positive effects of nanoscale powders in three-dimensional components, two fundamental prerequisites have to be satisfied.

Nanoscale powders generally have a very low bulk density and limited flowability. Owing to the particle fineness, pressing processes are found to be difficult because the roughness of the pressing mould is greater than the particle diameter of the powder, which causes high frictional values. Not least, the high air content generally present in the powder presents problems in the compaction.

A nanoscale structure should be preserved in the component even after the sintering, in order that the ceramic can satisfy the expectations placed on it. Coarsening of the structure as a result of high particle growth places in question the use of nanoscale starting powders and the effort needed to process them compared to the use of conventional powders.

As early as 1993, it was possible to show that nanoscale powders, for example TiO₂, Y₂O₃ and ZrO₂, can be sintered at much lower temperatures as conventional powders. However, this advantage only becomes effective when a homogeneous agglomerate-free structure can be established in the green body [Hahn, H.: Nanostructured materials 2(1993), 251-265; Hahn, H.: Unique Features and Properties of Nanostructured Materials. Advanced Engineering Materials 5(2003) 5, 277-284].

WO 01/030702 discloses a zirconium dioxide sol in which zirconium dioxide particles with a mean primary particle size of less than 20 nm are present in essentially unaggregated form. The sol is obtained by hydrothermal process from a polyether zirconium compound. The sol obtained in WO 01/030702 has a solids content of less than 5% by weight. To increase the concentration up to 20% by weight is laborious. Due to the low zirconium dioxide concentration, the sol is unsuitable for producing ceramic mouldings.

DE-A-19547183 discloses a process for preparing hydrophobized zirconium dioxide powders, in which zirconium dioxide particles with basic or amphoteric character and hydroxide groups on the surface are treated with an acylating agent in an inert water-immiscible solvent. It is possible with the hydrophobized zirconium dioxide powder to prepare stable aqueous dispersions which have a solids content of 30 to 60% by weight and can be processed further especially as slips. DE-A-19547183 also states that dispersions which comprise zirconium dioxide particles which have not been hydrophobized or stabilized with an anionic or cationic dispersant lead only to low solids contents. Such dispersions are unsuitable for producing ceramic bodies.

The prior art shows the active interest in zirconium dioxide ceramics and the starting materials. Dispersions have been described as a starting material, but their content of zirconium dioxide is too low or it is necessary to use previously surface-modified zirconium dioxide particles to prepare the dispersion.

It was therefore an object of the present invention to provide a process which provides a dispersion in a form which is suitable for producing mouldings and in which the disadvantages of the prior art are avoided. In particular, the form obtainable by the process shall be suitable for dry pressing.

The invention provides a process for preparing granules of oxidic or nonoxidic metal compounds, characterized in that a dispersion which comprises water and particles of oxidic or nonoxidic metal compounds and at least one dispersant is spray-dried,
where the proportion of oxidic or nonoxidic metal compounds is 40 to 70% by weight and the sum of the proportions of water and the particles is at least 70% by weight and
the particles have a BET surface area of 20 to 150 m²/g and a median of the particle size of less than 100 nm,
where the dispersant is present in the dispersion with a proportion of 0.25 to 10% by weight based on the oxidic or nonoxidic metal compounds and
where the spray-drying is performed by atomization with air in the cocurrent principle or fountain principle, and an air inlet temperature of 170 to 300° C. and an air outlet temperature of 90 to 130° C. are selected.

The essential feature in the process according to the invention is the use of a dispersion in which the oxidic or nonoxidic metal compounds have a high content and a small particle size.

In the process according to the invention, particles either of nonoxidic or of oxidic metal compounds may be used.

Suitable nonoxidic metal compounds are, for example, carbides such as tungsten carbide, titanium carbide, vanadium carbide, nitrides such as boron nitride, silicon nitride, aluminium nitride, borides such as aluminium boride, zirconium boride, tungsten boride, and silicides.

However, preference is given to using oxidic metal compounds, especially metal oxides. In particular, it is possible to use aluminium oxide, germanium oxide, hafnium oxide, indium oxide, copper oxide, magnesium oxide, silicon dioxide, titanium dioxide, titanates, yttrium oxide, tin oxide, zirconium dioxide and/or the mixed oxides thereof.

More preferably, pyrogenic metal oxides may be used. These are characterized in that they do not have internal surface area. They can be obtained by flame hydrolysis or flame oxidation.

Very particular preference is given to the use of pyrogenic zirconium dioxide. This may be a stabilized zirconium dioxide, especially a zirconium dioxide stabilized with 3 to 15% by weight, more preferably with 5±0.5% by weight, based on zirconium dioxide, of yttrium oxide. The zirconium dioxide powder present in the dispersion also comprises zirconium dioxide which may contain 1 to 4% by weight of hafnium dioxide as a companion of zirconium dioxide.

The metal oxide particles in the dispersion used may preferably have a BET surface area of 40 to 90 m²/g.

The median of the particle size in the dispersion used is less than 100 nm. The particle size may preferably be 10 to 100 nm and more preferably 40 to 70 nm. The particles include primary particles and aggregated primary particles.

The dispersion used in the process according to the invention comprises at least one dispersant. It is possible with preference to use polymers and copolymers of methacrylic acid and acrylic acid with low to moderate molecular weights and salts thereof.

It is also possible to use maleic anhydride copolymers. Further dispersants may be citric acid and phosphonobutane-tricarboxylic acid and salts thereof, or salts of polybasic acids, especially hydroxy acids, with polyvalent cations which may optionally still contain intact acid groups.

It is possible to obtain salts of polybasic acids with polyvalent cations, for example, by reacting suitable polybasic acids, especially polybasic hydroxy acids, with a smaller amount of polyvalent cations than is required for a full exchange of all acidic hydrogen atoms present. In the case of stoichiometric use of acids and cations, salts which no longer contain any intact acid groups are obtained.

In the process according to the invention, the dispersant used may preferably be at least one polycarboxylic acid and/or the salt of a polycarboxylic acid. More preferably, Dispex® and Dolapix® may be used.

In addition, in the process according to the invention, the dispersion used may contain 0.5 to 5% by weight, more preferably 1.5 to 4% by weight, based on the amount of oxidic and nonoxidic metal compounds, of an organic binder.

After the shaping, binders may increase the strength of a ceramic green body, such that it can be demoulded, processed or transported. The binder can increase the contact between powder particles and promote their cohesion.

Suitable binders may be polysaccharides, methylcellulose, polyvinyl alcohol, polyacrylic acid, polyethylene acid and/or waxes, particular preference being given to polyvinyl alcohol.

In addition, in the process according to the invention, the dispersion used may contain 1 to 15% by weight, based on the amount of oxidic and nonoxidic metal compounds, of a lubricant.

Lubricants may be used in order to reduce the internal friction of materials or the friction of the materials on walls. This can increase the homogeneity of ceramic bodies and lower the wear on the machines.

Suitable lubricants have a high adhesive strength buta low shear strength. Commonly used lubricants are paraffin wax, polyethylene glycols (PEGs), butyl stearate, stearic acid and stearates of ammonium, aluminium, lithium, magnesium, sodium and zinc, oleic acid, graphite and/or boron nitride. More preferably, stearic acid and stearates may be used.

Particular preference is given to a process in which the dispersion used contains 1.5 to 3.5% by weight of polyvinyl alcohol and 4 to 6% by weight of a stearate, based in each case on the amount of oxidic and nonoxidic metal compounds.

In the process according to the invention, it is also possible to use a dispersion which comprises one or more bases selected from the group consisting of alkali metal hydroxides, alkaline earth metal hydroxides, ammonia, amines such as methylamine, dimethylamine, trimethylamine, ethylamine, diphenylamine, triphenylamine, toluidine, ethylenediamine, diethylenetriamine and/or tetraalkyl-ammonium hydroxides such as tetramethylammonium hydroxide or tetraethylammonium hydroxide.

The zirconium dioxide powder present in the dispersion used also comprises zirconium dioxide which may contain 1 to 4% by weight of hafnium dioxide as a companion of zirconium dioxide. In addition, the zirconium dioxide may be present in a form stabilized by metal oxide. In particular, this may be yttrium oxide, which is present at 3 to 15% by weight, more preferably at 5±0.5% by weight, based on zirconium dioxide.

Particular preference is given to an embodiment of the process according to the invention in which the dispersion used
contains pyrogenic zirconium dioxide particles having a BET surface area of 60±15 m²/g and a median of the particle size of 70 to 100 nm,
contains 45 to 55% by weight of zirconium dioxide particles,
contains 2 to 5% by weight, based on zirconium dioxide, of a polycarboxylic acid and/or salts thereof, and
the pH of the dispersion is 9 to 11.

Pyrogenic zirconium dioxide particles may be particles stabilized by yttrium oxide.

The dispersion used is stable for at least 2 months, generally at least 6 months, with respect to sedimentation, caking and thickening. In a shear rate range of 1 to 1000 s⁻¹ and a temperature of 23° C., the dispersion preferably has a viscosity of less than 1000 mPas and more preferably a viscosity of less than 100 mPas.

Particular preference is also given to an embodiment of the process according to the invention in which the dispersion used
contains pyrogenic zirconium dioxide particles having a BET surface area of 60±15 m²/g and a median of the particle size of 70 to 100 nm,
contains 50±5% by weight of zirconium dioxide particles,
contains 2 to 5% by weight, based on zirconium dioxide, of a polycarboxylic acid and/or salts thereof,
1.5 to 3.5% by weight of polyvinyl alcohol and
4 to 6% by weight of a stearate.

The dispersion used is obtainable by predispersing a powder of an oxidic or nonoxidic metal compound in water in the presence of a dispersant at an energy input of less than 200 kJ/m³ and dividing the resulting predispersion into at least two substreams, decompressing these substreams through a nozzle in a high-energy mill under a pressure of at least 500 bar, and allowing them to meet in a gas- or liquid-filled reaction chamber and grinding them at the same time, and if appropriate subsequently adjusting them to the desired content with further dispersant and/or binder, lubricant or a mixture of binder and lubricant.

The invention further provides a granule of oxidic or nonoxidic metal compounds obtainable by the process according to the invention.

Particular preference is given to a granule of zirconium dioxide which has the following features:
mean granule diameter d₅₀ of 40 to 80 μm,
bulk density 0.6 to 1 g/cm³,
mean granule strength 0.2-1.5 MPa
and, on compression of 50 to 200 MPa,
a force transmission of 65 to 85%
a coefficient of wall friction of 0.11 to 0.20
a splitting tensile strength of 2 to 4 MPa.

The invention further provides for the use of inventive granules of oxidic or nonoxidic metal compounds for producing ceramic mouldings, especially by dry pressing.

### EXAMPLES

Feedstocks

Zirconium dioxide powder: Precursor solutions used: A mixture of 1271 g/h of the solution consisting of 24.70% by weight of zirconium octoate (as ZrO₂), 39.60% by weight of octanoic acid, 3.50% by weight of 2-(2-butoxyethoxy)ethanol and 32.20% by weight of petroleum spirit, and 29 g/h of a solution consisting of 30.7% by weight of yttrium nitrate Y(NO₃)₃.4H₂O and 69.3% by weight of acetone, are sprayed with air (3.5 Nm³/h). The resulting droplets have a droplet size spectrum d₃₀ of 5 to 15 μm. The droplets are combusted into a reaction chamber in a flame formed from hydrogen (1.5 Nm³/h) and primary air (12.0 Nm³/h). 15.0 Nm³/h of (secondary) air are also introduced into the reaction chamber. Subsequently, in a cooling zone, the hot gases and the solid product are cooled. The resulting yttrium-stabilized zirconium dioxide is deposited in filters.

The zirconium dioxide powder has a BET surface area of 47 m²/g, a mean primary particle diameter of 13.7 nm, a mean aggregate diameter of 111 nm, a content of ZrO₂ of 94.5% by weight, of Y₂O₃ of 5.4% by weight, of chloride of <0.05% by weight and of carbon of 0.12% by weight.

Zirconium dioxide dispersion: A batch vessel is initially charged with 42.14 kg of demineralized water and 1.75 kg of Dolapix® CE64 (from Zschimmer and Schwarz) and then, applying suction tube of the Ystral Conti-TDS 3 (stator slots: 4 mm ring and 1 mm ring, rotor/stator distance approx. 1 mm) under shear conditions, 43.9 kg of the zirconium dioxide powder prepared above are added. After the incorporation has ended, the suction nozzle is closed and shearing is continued at 3000 rpm for 10 min. This predispersion is conducted in five passes through a Sugino Ultimaizer HJP-25050 high-energy mill at a pressure of 2500 bar with diamond nozzles of diameter 0.3 mm. It has a content of zirconium mixed oxide powder of 49.74% by weight, a median of 99 nm, a pH of 9.6 and a viscosity at 1000 s⁻¹/23° C. of 27 mPas. It is stable to sedimentation, caking and thickening for at least 6 months.

Preparation of Inventive Granules

The zirconium dioxide dispersion is admixed with the amounts of binder and lubricant specified in Table 1. The physicochemical data of the resulting dispersions are reported in Table 1.

The dispersion viscosities measured at a shear rate of 240 s⁻¹, after addition of the organic additives, were 31.6 mPas (Example D4) and 29.0 mPas (Example D6). The increased amount of additive becomes noticeable in a slight increase in the viscosities. With a content of organics of only 6%, the dispersions had viscosities of 29.0 mPas (Example D3) and 20.3 mPas (Example D5).

The binder-lubricant pairing from Example D2 led to a rise in viscosity in the dispersion and hence to a reduction in the yield of pressed granule in the desired particle size range, but provides very good pressing results. The pairings from Example D3 and Example D5 are, in terms of pressing behaviour, only marginally below the values of the pairing from Example D2, but provide significantly better suspension properties and better sprayability.

TABLE 1
Composition and properties of the dispersions (D)

| | ZrO₂ | | Lubricant | |
|---|---|---|---|---|
| | content | Binder content | content | |
| Example | % by wt. | % by wt. | % by wt. | pH |
| D0 | 49.7 | 0 | 0 | 9.6 |
| D1 | 45.3 | Acrylate disp. 2 | Stearate 4 | 10.2 |
| D2 | 45.1 | PVA Moviol 20-98 2 | Stearate 4 | 10.2 |
| D3 | 45.2 | PVA Moviol 4-88 2 | Stearate 4 | 10.1 |
| D4 | 44.9 | PVA Moviol 4-88 | Stearate 5 | 10.3 |
| | | 2.5 | | |
| D5 | 45.3 | PAF 35 2 | Stearate 4 | 10.2 |
| D6 | 44.8 | PAF 35 | Stearate 5 | 10.2 |
| | | 2.0 | | |

The spray drying was performed by atomization with air in the co-current principle and is performed at an air inlet temperature of 280° C. and an air outlet temperature of 120° C.

The physicochemical properties of the resulting granules are reported in Table 2.

TABLE 2
Properties of the granules (G)

| | Residual | | | |
|---|---|---|---|---|
| | moisture* | d₁₀ | d₅₀ | d₉₀ |
| Example | % | μm | μm | μm |
| G0 | 1.16 | 16 | 39 | 81 |
| G1 | 0.52 | 17 | 33 | 63 |
| G2 | 1.36 | 23 | 51 | 96 |
| G3 | 0.63 | 19 | 40 | 78 |
| G4 | 0.38 | 16 | 33 | 65 |
| G5 | 0.63 | 17 | 36 | 71 |
| G6 | 0.38 | 16 | 33 | 65 |

*at 50° C.

The properties of the granules from Examples G1 to G6, in spite of the high amount of organics at a total of 7.5%, based on the solids content, remain substantially unchanged compared to the batches with organics content only 6%.

Production of Green Bodies by Dry Pressing

The granules from Examples G1 to G6 were pressed. The test parameters can be taken from Table 3.

TABLE 3
Test parameters

Testing machine: UMP Zwick Z250/SN5A
Pressing tool: Instrumented variants from Dresden Technical
University, die No. 18 (with expulsion chamfer), upper punch
play 32 μm, lower punch play 54 μm
Tool material: 210Cr46 hardened tool steel, HRC 62 ± 3
Tool diameter: 20 mm
Method: Path control up to 2 kN, then force-controlled up to
150 MPa, 100 MPa, 50 MPa rigid die ELVW = 47 mm
Moulding mass: 18 g
Loading rate: 1.4 kN/s
Load removal rate: 1.4 kN/s
Climatic conditions: 22° C., 40% rel. air humidity

The physicochemical properties of the pressed green bodies can be taken from Table 4.

In the granules, all phases of the pressing from the loading to the expulsion were free of inhomogeneities in the form of stick-slip mechanisms or pressing noise.

The compressed mouldings have an impeccable appearance with highly shiny outer surfaces, and lack of axial colour gradients and abrasion.

TABLE 4
Physicochemical properties of the compressed green
bodies (GB)

| | F₂/F₁^{a)} | | F_{Adhesion/Sliding}^{c)} | r^{d)} | sₛₚ^{e)} |
|---|---|---|---|---|---|
| Example | % | μ_{ω}^{b)} | kN | g/cm³ | N/mm² |
| GB1 | 69.7 | 0.198 | 6.0/6.6 | 2.7 | 2.18 |
| GB2 | 70.9 | 0.187 | 5.8/7.0 | 2.73 | 2.88 |
| GB3 | 75.2 | 0.155 | 4.6/4.8 | 2.75 | 3.13 |
| GB4 | 71.2 | 0.187 | 6.3/6.3 | 2.74 | 3.06 |
| GB5 | 69.5 | 0.198 | 6.2/7.0 | 2.72 | 2.79 |
| GB6 | 76.1 | 0.147 | 4.5/5.5 | 2.73 | 2.94 |

^{a)}Pressure transmission;
^{b)}wall friction;
^{c)}expulsion forces;
^{d)}pressing density;
^{e)}splitting tensile strength

The values measured for the splitting tensile strength were at an unusually high level, and the changes undertaken in the additive system have even led to an increase in the strength.

The result is that all friction-specific parameters exhibit a clear trend in a favourable direction (Table 4). The profiles of the parameters with time all have features important for good pressing behaviour, i.e. high force transmission, timely and distinct breakage of the moulding from the die wall on load removal, and low remaining residual forces and stresses.

The improved friction-specific parameters bring about a further lowering in the shear stresses relevant to pressing faults, and a reduction in the pressure stress gradients in axial and radial direction.

Production of sintered Bodies

The granule from Example G4 was pressed by means of uniaxial pressing to tablets (Ø12 mm) and to discs (60×60×7 mm). The pressures selected were 50, 100 and 150 MPa.

In addition, discs and tablets for an isostatic redensification with low pressure of 40 MPa were precompressed uniaxially, for which single-sided pressing was also employed in addition to double-sided pressing.

The isostatic redensification was performed on the tablets at 500, 750 and 1000 MPa, and on the discs at 250 and 350 MPa. The green density of the pressed bodies was then determined.

After the organic additives had been removed by temperature treatment, the pore size distribution of the bodies was determined by means of mercury intrusion and by means of nitrogen adsorption.

The pressure less sintering was performed under air at different temperatures.

The sintering progress was monitored via density measurements by means of hydrostatic weighing. Polished-surface and fractured-surface images of the sintered samples were produced.

After determination of a sintering region in which a closed porosity was achievable hot isostatic compaction step to produce fully compacted samples took place.

The samples were subsequently characterized by means of density measurement, quantitative image evaluation of structure abrasions and determination of the mechanical characteristics (4-point flexural fracture resistance to DIN-EN 853-1, modulus of elasticity to DINV-ENV 853-2, Vickers hardness HV10 to EN 843-4) and pressure creep test.

The fracture toughness was determined by means of calculation from the diagonal lengths and fracture lengths on Vickers hardness impressions according to the models of Niihara, Anstis and Shettey.

Results:

For an isostatic pressure of 1 GPa, a green body density of 3.75 g/cm³ is achieved in tablets, which corresponds to a relative density of 61.8%.

By means of uniaxial prepressing and isostatic postcompressing of the square slabs at 350 MPa, a green body density of 3.16 g/cm³ (52% rel. density) was achieved.

The specimens had no defects in the form of chips or cracks. The inventive granule was very efficiently compressible.

The pore size distributions, which were determined by means of mercury porosimetry, show a reduction in the pore diameter with rising pressure (Image 3). At an isostatic pressure of 350 MPa, the median of the distribution was at 9 nm.

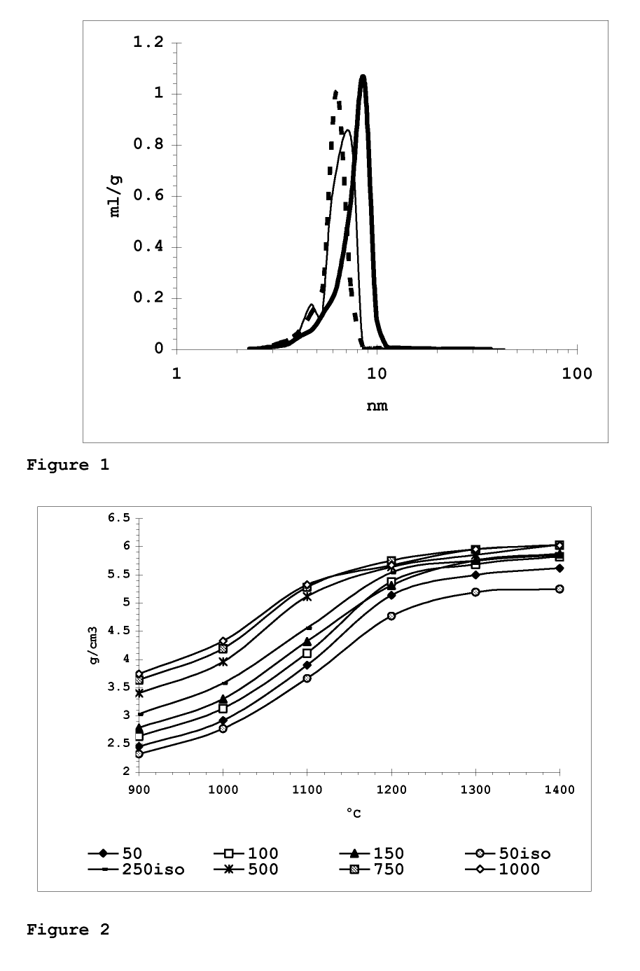

With the application of pressures above 350 MPa, the pore size distributions were shifted into a range which was below the detection limit of mercury intrusion. Nitrogen adsorption was therefore used to characterize the samples. The pore size distributions of the samples compacted isostatically at 500 MPa [symbol] 750 MPa [symbol] and 1000 MPa [symbol] were calculated from the desorption curves (FIG. 1).

The distribution curves in FIG. 1 (cumulative pore volume in ml/g against pore volume in nm) show that a further decrease in the pore size was also achievable at high pressures. The median of the distribution at a pressure of 1 GPa was 6.5 nm.

It becomes clear from the profiles of the compression of samples which have been pressed with different pressures shown in FIG. 2 (sintering density in g/cm³ against temperature in ° C.) that a relatively high sintered density was also achievable at different temperatures with higher pressure and hence higher green density. The shortfall in the compaction is not made up even at higher sintering temperatures.

The cause of this effect can be found in the higher homogeneity in the green body as a result of complete destruction of agglomerates and granule fragments at higher pressures. Even though isostatic compaction is known to lead to a higher homogeneity of the green body structure, it becomes discernible on comparison of the curves between samples pressed uniaxially at 50 MPa and samples compacted isostatically that the sintered densities of the isostatically compacted samples are significantly lower than those of the uniaxially compacted samples (FIG. 2).

This difference is a manifestation of the fact that the air present in the pressed granule was able to escape better in uniaxial presses than was the case for isostatic compaction. For this reason, uniaxial precompression is advantageous for isostatic shaping.

Measurements of the density of the sintered samples by means of hydrostatic weighing demonstrated that the open porosity had been very substantially eliminated from a sintering temperature of 1300° C. When a sintering temperature of 1400° C. was employed, it was possible to achieve sintered densities of 6.02 to 6.04 g/cm³ by means of ambient pressure sintering for all samples which had been compacted at pressures of >250 MPa. For a hot isostatic postcompression, samples presintered at 1200° C. or 1300° C. were employed.

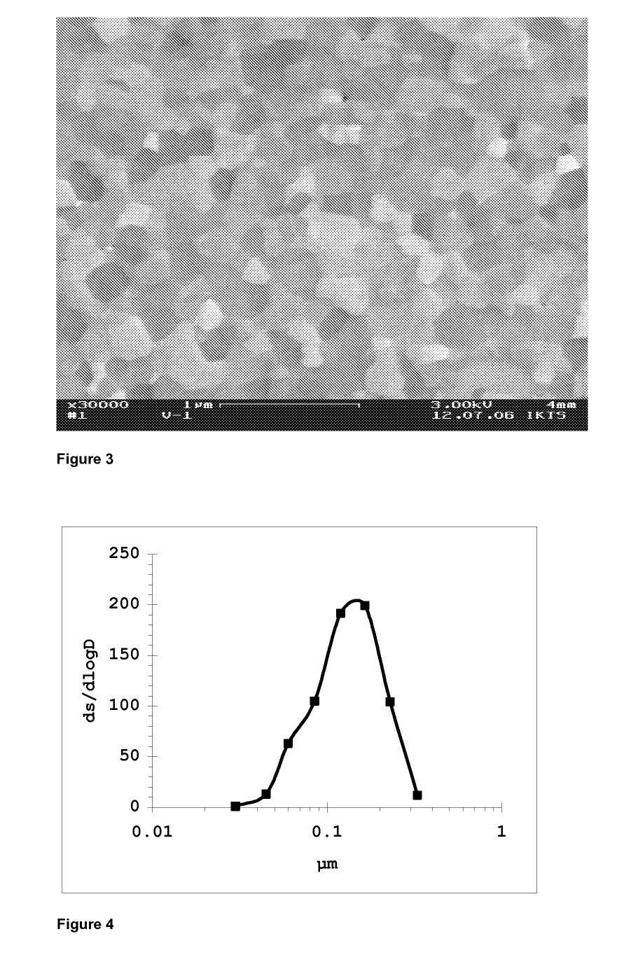

An HIP treatment of the presintered samples brought about a further increase in the density to 6.07 g/cm³, which corresponds to the theoretical material density. The achievement of virtually full compaction is supported by the FESEM structure image in FIG. 3 (FESEM structure image of a sample postcompacted isostatically at 750 MPa, which had been presintered at 1200° C. at ambient pressure and then sintered by means of HIP).

The results of the particle size distribution in the sintered structure obtained by means of quantitative image evaluation of structure images (FIG. 4) allow a median of the distribution at approx. 180 nm to be found. Five percent of the particles are smaller than 76 nm; 95% are smaller than 356 nm.

The mechanical property data of the sintered bodies can be taken from Table 5.

TABLE 5
Mechanical characteristics^{a)}

| | |
|---|---|
| 4-Point flexural strength [MPa] | 1152 ± 206 |
| Modulus of elasticity [GPA] | 203 |
| Weibull modulus | 6 . . . 7 |
| K_{IC (ANSTIS)} [MPa m^{1/2}] | 3.4 |
| K_{IC (NIIHARA HP)} [MPa m^{1/2}] | 5.1 |
| K_{IC (NIIHARA PQ)} [MPa m^{1/2}] | 4.5 |
| K_{IC (SHETTY)} [MPa m^{1/2}] | 5.5 |
| Vickers hardness [HV10] | 1372 ± 36 |

^{a)}pressed uniaxially, postcompacted isostatically, sintered hot-isostatically

At a temperature above 1000° C., after a transition region, the sample exhibits stationary creep behaviour, which can be attributed to particle interface sliding processes and particle interface diffusion processes. When this property is investigated on samples in a high-temperature bending test, the samples bent significantly from 1200° C. without destroying the specimen.

1. A process for preparing granules of oxidic or nonoxidic metal compounds, wherein a dispersion which comprises water and particles of oxidic or nonoxidic metal compounds and at least one dispersant is spray-dried,
where the proportion of oxidic or nonoxidic metal compounds is 40 to 70% by weight and the sum of the proportions of water and the particles is at least 70% by weight and
the particles have a BET surface area of 20 to 150 m²/g and a median particle size is less than 100 nm,
where the dispersant is present in the dispersion within a proportion of 0.25 to 10% by weight based on the oxidic or nonoxidic metal compounds and
where the spray-drying is performed by atomization with air in the cocurrent principle or fountain principle at an air inlet temperature of 170 to 300° C. and an air outlet temperature of 90 to 130° C.

2. The process according to claim 1, wherein the oxidic metal compound is selected from the group consisting of aluminium oxide, germanium oxide, hafnium oxide, indium oxide, copper oxide, magnesium oxide, silicon dioxide, titanium dioxide, titanates, tin oxide, zirconium dioxide and mixtures thereof.

3. The process according to claim 1, wherein the oxidic metal compound used is pyrogenic zirconium dioxide.

4. The process according to claim 3, wherein the zirconium dioxide powder is a zirconium dioxide powder stabilized with yttrium oxide.

5. The process according to claim 2, wherein the BET surface area of the metal oxide particles is 40 to 70 m²/g.

6. The process according to claim 1, wherein the median of the particle size used is 10 to 100 nm.

7. The process according to claim 1, wherein the dispersant is at least one of a polycarboxylic acid and a salt of a polycarboxylic acid.

8. The process according to claim 1, wherein the dispersion used contains 0.5 to 5% by weight of an organic binder, based on the amount of the oxidic or nonoxidic metal compounds.

9. The process according to claim 1, wherein the dispersion used contains 1 to 15% by weight of a lubricant, based on the amount of the oxidic or nonoxidic metal compounds.

10. The process according to claim 1, wherein the dispersion used contains 1.5 to 3.5% by weight of polyvinyl alcohol and 4 to 6% by weight of a stearate based on the amount of oxidic or nonoxidic metal compounds.

11. The process according to claim 1, wherein the dispersion used comprises one or more bases selected from the group consisting of alkali metal hydroxides, alkaline earth metal hydroxides, ammonia, amines, tetraalkylammonium hydroxides and mixtures thereof.

12. The process according to claim 1, wherein the dispersion, as particles,
contains pyrogenic zirconium dioxide particles having a BET surface area of 60±15 m²/g and a median particle size of 70 to 100 nm,
contains 45 to 55% by weight of zirconium dioxide particles,
contains 2 to 5% by weight, based on zirconium dioxide, of a polycarboxylic acid and/or salts thereof, and
the pH of the dispersion is 9 to 11.

13. The process according to claim 1, wherein the dispersion, as particles,
contains pyrogenic zirconium dioxide particles having a BET surface area of 60±15 m²/g and a median particle size of 70 to 100 nm,
contains 50±5% by weight of zirconium dioxide particles,
contains 2 to 5% by weight, based on zirconium dioxide, of a polycarboxylic acid and/or salts thereof,
1.5 to 3.5% by weight of polyvinyl alcohol and
4 to 6% by weight of a stearate.

14. A granule of oxidic or nonoxidic metal compounds prepared by the process according to claim 1.

15. The granule according to claim 14, wherein the metal compound is zirconium dioxide and it has the following features:
a mean granule diameter d50 of 40 to 80 μm,
a bulk density of 0.6 to 1 g/cm³,
a mean granule strength of 0.2-1.5 MPa
and, on compression of 50 to 200 MPa,
a force transmission of 65 to 85%
a coefficient of wall friction of 0.11 to 0.20 and
a splitting tensile strength of 2 to 4 MPa.

16. A ceramic moulding comprising granules of oxidic or nonoxidic metal compounds according to claim 14.
